(19) United States
(12) Patent Application Publication
(10) Pub. No.: US 2009/0211649 A1
(43) Pub. Date: Aug. 27, 2009

(54) Fuel cutoff valve

(75) Inventors: Natsushi Miura, Aichi-ken (JP); Norihiro Yamada, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/379,499

(22) Filed: Feb. 24, 2009

(30) Foreign Application Priority Data
Feb. 27, 2008 (JP) 2008-046079

(51) Int. Cl. F16K 31/28; F16K 24/00; B60K 15/035

(52) U.S. Cl. 137/202

(57) ABSTRACT

The fuel cutoff valve includes a casing and a float mechanism. The float mechanism is composed of an outside float and an inside float. The outside float includes an outside float body of round tubular shape having a float chamber that connects with a valve chamber via a through-hole formed in its upper part; and an outside valve portion disposed on the upper part of the outside float body and adapted to open and close an outside connecting passage. The inside float has an inside float body accommodated and adapted to rise and fall within the float chamber, and an inside valve portion disposed on the upper part of the inside float body and adapted to open and close the inside connecting passage through the through-hole.

This application claims the benefit of and priority from Japanese Application No. 2008-046079 filed Feb. 27, 2008, the content of which is incorporated herein by reference.

### BACKGROUND OF THE INVENTION

1. Field of the Invention

The present invention relates to a fuel cutoff valve installed at the top of a fuel tank and adapted to open and close a path between the fuel tank interior and an outside passage, depending on the fuel level in the fuel tank.

2. Description of the Related Art

Fuel cutoff valves include those having an arrangement whereby spilling of fuel to the outside when fueling is halted, or if the vehicle pitches, is prevented through a number of floats that rise and fall at different fuel levels (JP-A 2004-364491 and JP-A 11-229984). These fuel cutoff valves have designs furnished with a casing provided with a multiplicity of valve chambers that are divided by partition walls and that are arrayed in a row and with floats that are respectively housed in the valve chambers; the floats rise and fall depending on the liquid level of fuel that has entered the respective fuel chambers.

However, with these conventional fuel cutoff valves, because the floats are installed within valve chambers that are divided by partition walls, the casing tends to be bulky, complex in shape, and/or asymmetrical, resulting in the problems of poor formability and lower productivity.

### SUMMARY

An advantage of some aspects of the invention is to provide a fuel cutoff valve of simple design and excellent formability.

According to an aspect of the invention is provided with a fuel cutoff valve installed on a top of a fuel tank and adapted to open and close a conduit between the fuel tank interior and an outside passage depending on fuel level in the fuel tank. The fuel cutoff valve comprises: a casing having a valve chamber that communicates with the fuel tank interior, an outside connecting passage and an inside connecting passage that respectively connect with the valve chamber and with the outside passage, a communication hole for introducing fuel into the valve chamber, and a vent hole situated above the communication hole; and a float mechanism having an outside float and an inside float that are housed within the valve chamber and that are respectively adapted to open and close the outside connecting passage and open and close the inside connecting passage by rising and falling depending on the fuel level. The outside float has a tubular shaped outside float body having a float chamber that connects with the valve chamber via a through-hole formed in an upper part of the outside float body, and an outside valve portion disposed on an upper part of the outside float body and adapted to open and close the outside connecting passage; and the inside float has an inside float body accommodated within and adapted to rise and fall in the float chamber, and an inside valve portion disposed on an upper part of the inside float body and adapted to open and close the inside connecting passage through the through-hole.

According to this first mode, when fuel is being supplied to a fuel tank that employs the fuel cutoff valve, and the fuel has reached a first liquid level, the fuel will flow into the valve chamber whereupon either the outside float or the inside float will rise, and either the outside connecting passage or the inside connecting passage will be closed off by the corresponding float portion. In this shutoff state, the passage area of the valve chamber and the outside passage will be reduced and internal pressure of the tank will rise. When the surface of the liquid inside the inlet pipe rises due to the rise in tank internal pressure, the auto stop will operate to shut off the supply of fuel from the fuel gun. When the fuel level next reaches a second liquid level, the other of the outside float and the inside float will now rise, and either the outside connecting passage or the inside connecting passage will be closed off by the corresponding float portion. Thus, the fuel tank interior will be sealed off from the outside passage, preventing spillage of fuel to the outside.

According to the first mode, since the inside float is housed within the float chamber of the outside float, space in the outside float can be utilized effectively to achieve a more compact design. Moreover, since it suffices to form a valve chamber able to house the larger outside float thus making it unnecessary to form valve chambers corresponding to multiple floats, the casing may have a simpler design. Additionally, where the outside float has been given round columnar shape, the casing can be given a simple round tubular shape, thereby avoiding the need for a complicated shape of multiple valve chambers that combines multiple tube sections as described in the prior art and affording greater ease of die machining, formability, and parts design.

Moreover, as the outside float body has a through-hole in its upper part, and the inside float rises and falls so that the inside valve portion of the inside float opens and closes the inside connecting passage through the through-hole, a simple design whereby the two float portions are situated on the same axis can be achieved.

According to a second mode, the outside connecting passage has larger passage area than the inside connecting passage; the outside float will close the outside connecting passage when the fuel level in the fuel tank has reached a first liquid level; and the inside float will close the inside connecting passage when the fuel level in the fuel tank has reached a second liquid level higher than the first liquid level. With this arrangement, the outside float can operate the auto stop during fueling, while the inside float can operate to prevent outflow of fuel during vehicle pitch, for example.

Where the casing has a bottomed cup shape, the outside connecting passage and the inside connecting passage may be respectively formed in the upper wall. With this arrangement, there will be no need to provide respective connecting passages corresponding to multiple valve chambers that have been divided into multiple sections as described in the prior art. In a preferred configuration of the connecting passages, the outside connecting passage will have arcuate shape of prescribed width around the inside connecting passage with a circular shape centered on the inside connecting passage.

In an arrangement according to a third mode, the casing includes a casing body of round tubular shape and a base member that partially closes the opening at the bottom of the casing body; and the base member includes a guide portion that intervenes between the outside float body and the inside float body. With this arrangement, since the guide portion guides the outside float body and the inside float body in the direction of their ascent and descent so that tilting of these components can be reduced.

In an arrangement according to a fourth mode, the outside float body includes a vent hole through which the float chamber and the space to the outside of the outside float body communicate at times that the outside connecting passage is closed off by the outside float and the inside connecting passage is left open by the inside float. With this arrangement, it is a simple matter to realize a design for constricting passage area to a narrow area at times that the connecting passage is closed off by the float portion which has been closed due to low fuel level.

In yet another mode, there may be employed an arrangement wherein the outside connecting passage has smaller passage area than the inside connecting passage; the inside float will closes the inside connecting passage when the fuel level inside the fuel tank has reached a first liquid level; and the outside float will close the outside connecting passage when the fuel level inside the fuel tank has reached a second liquid level higher than the first liquid level. With this arrangement, the inside float can operate the auto stop during fueling, while the outside float can operate to prevent outflow of fuel during vehicle pitch, for example.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a sectional view depicting a fuel cutoff valve according to a first embodiment of the present invention, shown attached to the upper part of a fuel tank of an automobile,

FIG. 2 is an exploded sectional view of the fuel cutoff valve,

FIG. 3 is a perspective view depicting the fuel cutoff valve in exploded view and depicting its constituent parts in partial cutaway view,

FIG. 4 shows operation of the fuel cutoff valve,

FIG. 5 shows operation, continuing from FIG. 4,

FIG. 6 is a sectional view depicting the fuel cutoff valve according to a second embodiment.

FIG. 7 is a sectional view depicting the fuel cutoff valve according to a third embodiment,

FIG. 8 shows operation, continuing from FIG. 7,

FIG. 9 is a sectional view depicting the fuel cutoff valve according to a fourth embodiment,

FIG. 10 is a sectional view depicting principal parts of the fuel cutoff valve according to a modified embodiment of FIG. 1, and

FIG. 11 is a sectional view depicting principal parts of the fuel cutoff valve according to another modified embodiment of FIG. 1.

### DESCRIPTION OF THE PREFERRED EMBODIMENTS

### A. General Design of Fuel Cutoff Valve 10

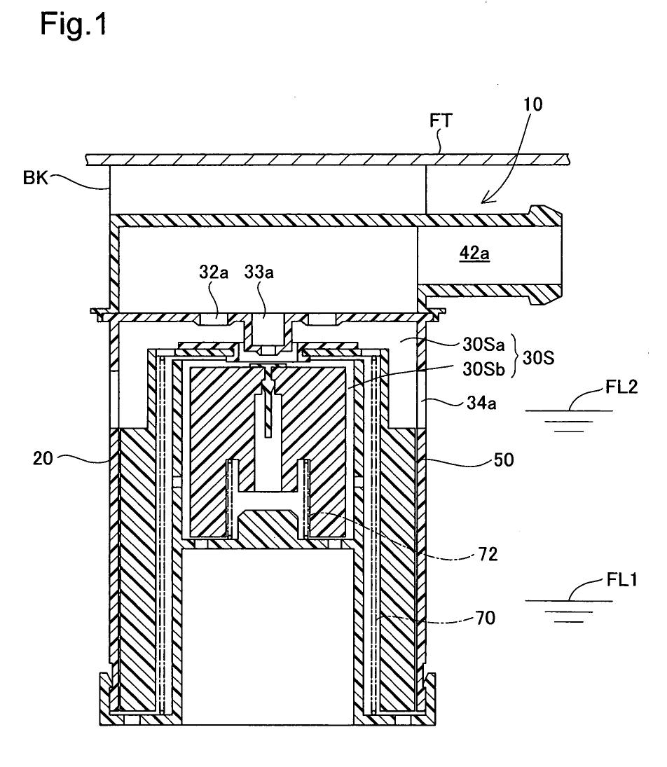

FIG. 1 is a sectional view depicting a fuel cutoff valve 10 according to a first embodiment of the present invention, shown attached to the upper part of a fuel tank FT of an automobile. In FIG. 1, the fuel cutoff valve 10 is of so-called in-tank design attached to the interior of the fuel tank FT made of metal or the like through a bracket BK which is situated in the fuel tank FT. The valve serves as a full tank regulator valve for regulating outflow of fuel to the canister, as well as functioning as an auto stop when the fuel level has reached a first liquid level FL1 during fueling; it also serves as rollover valve for preventing spillage of fuel when the fuel level has reached a second liquid level FL2 at times of vehicle pitch etc. The fuel cutoff valve 10 includes a casing 20, a float mechanism 50, and springs 70, 72 as principal components. The design of the parts of the fuel cutoff valve 10 will be discussed below.

(2) Design of Fuel Cutoff Valve 10 Parts

### (2)-1 Casing 20

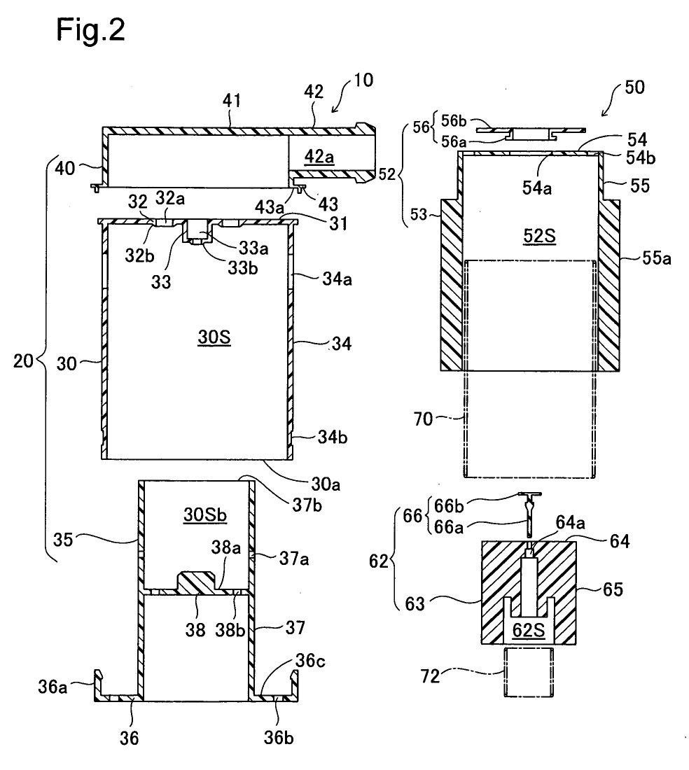

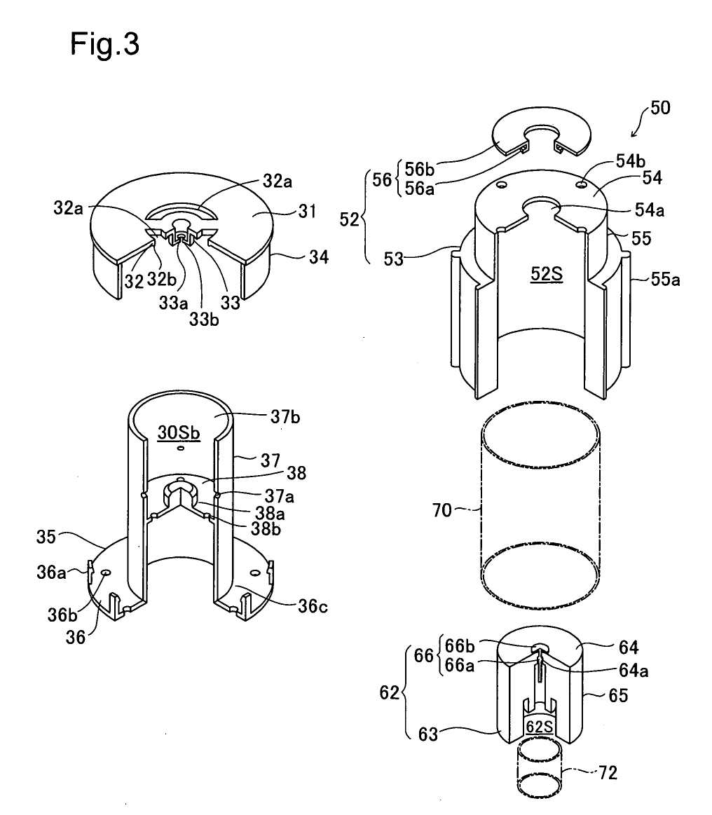

FIG. 2 is an exploded sectional view of the fuel cutoff valve 10; and FIG. 3 is a perspective view depicting the fuel cutoff valve 10 in exploded view and depicting its constituent parts in partial cutaway view. The casing 20 includes a casing body 30, a base member 35, and a cover 40. The space enclosed by the casing body 30 and the base member 35 defines a valve chamber 30S, and a float mechanism supported on springs 70, 72 is housed in the valve chamber 30S.

The casing body 30 has a cup shape enclosed by an upper wall 31 and a side wall 34; and an opening 30a at its bottom. An outside passage-forming projection 32 that projects downward is formed in proximity to the upper wall 31. The outside passage-forming projection 32 has arcuate sections of prescribed width formed at two locations. The outside passage-forming projection 32 is perforated respectively by outside connecting passages 32a of shape similar to but slightly smaller than the contours of the outside passage-forming projection 32 and that pass through and connect to the valve chamber 30S. This outside passage-forming projection 32 juts out so as to surround the outside connecting passages 32a about their entire circumference so that an outside seal portion 32b is defined to the valve chamber 30S side of the outside connecting passages 32a. An inside passage-forming projection 33 of round tubular shape jutting downward is formed in the center portion of the upper wall 31. An inside connecting passage 33a that connects to the valve chamber 30S passes through the inside passage-forming projection 33. An inside seal portion 33b is defined to the valve chamber 30S side of the inside connecting passage 33a.

Vent holes 34a for connecting the valve chamber 30S to the fuel tank FT interior are formed in the side wall 34. The vent holes 34a are through-holes which are situated above the first liquid level FL1 (FIG. 1), at four locations spaced apart by 90° in the circumferential direction. A catch slot 34b is formed in the lower part of the side wall 34 to receive installation of the base member 35.

The base member 35 is a member that partially closes the opening 30a of the casing body 30, and that supports the float mechanism 50 in such a way as to permit it to rise and fall inside the valve chamber 30S. The base member 35 includes an outside base plate 36 installed on the bottom of the casing body; a guide portion 37 formed above the outside base plate 36; and an inside base plate 38 formed at midpoint in the guide portion 37. Catch hooks 36a adapted to be engaged in the catch slot 34b of the casing body 30 are formed on the outside base plate 36, and the outside base plate 36 is attached to the casing body by engaging the catch hooks 36a in the catch slot 34b. A spring support portion 36c for supporting the lower end of the spring 70 is formed on the upper face of the outside base plate 36. The outside base plate 36 is also perforated by communication holes 36b. The communication holes 36b are formed at multiple locations a prescribed distance away from the center of the outside base plate 36.

From the outside base plate 36, the guide portion 37 projects upward with a tubular shape into the interior of the valve chamber 30S, thereby dividing the valve chamber 30S into an outside valve chamber 30Sa and an inside valve chamber 30Sb as depicted in FIG. 1. The outside valve chamber 30Sa and the inside valve chamber 30Sb communicate through an upper opening 37b and a communication hole 37a formed in the guide portion 37.

The inside base plate 38 is circular in shape, and a spring support portion 38a for supporting the lower end of the spring 72 is formed on its upper face. Communication holes 38b are formed in the inside base plate 38. The communication holes 38b are formed at several locations encircling the spring support portion 38a.

The cover 40 includes a cover body 41; a tube portion 42 that projects to the side from the center of the cover body 41; and a flange 43 formed on the outside perimeter of the cover body 41, these parts being formed as an integral unit. A tube passage 42a is formed in the tube portion 42; a first end of this tube passage 42a connects to the valve chamber 30S through the outside connecting passage 32a and the inside connecting passage 33a, while the other end connects to the canister (not shown) side. A welding portion 43a adapted to be welded to the upper end of the casing body is formed at the bottom of the flange 43.

(2)-2 Float Mechanism 50

The float mechanism 50 includes an outside float 52; and an inside float 62 situated to the inside of the outside float 52. The outside float 52 includes an outside float body 53, and an outside seat member 56 (outside valve portion) installed on the top of the outside float body 53. The outside float body 53 is of cup shape defined by an upper wall 54 and a side wall 55 of tubular shape, and its interior space is open at the bottom to define a float chamber 52S. A through-hole 54a is formed in the center of the upper wall 54, and vent holes 54b through which the float chamber 52S and the valve chamber 30S communicate are formed in the outside peripheral portion. Guide ribs 55a with ribbed contours that extend in the vertical direction are formed on the outside peripheral portion of the side wall 55. The guide ribs 55a are adapted to slide along the inner wall of the casing body 30.

The outside seat member 56 includes a mounting portion 56a adapted mount within the rim of the through-hole 54a; and a seat portion 56b of round disk shape formed at the top of the mounting portion 56a and adapted to alternately seat against and unseat from the outside seal portion 32b; these are integrally molded from rubber material. The outside seat member 56 is attached to the outside float body 53 through engagement of the mounting portion 56a within the through-hole 54a, and the seat portion 56b is adapted to undergo elastic deformation when seated against the outside seal portion 32b so as to enhance sealing.

The inside float 62 includes an inside float body 63, and an inside seat member 66 (inside valve portion) installed on the top of the inside float 62. The inside float body 63 is of cup shape defined by an upper wall 64 and a side wall 65 of tubular shape, and its interior space is open at the bottom to define a float chamber 62S. A valve mounting hole 64a adapted to receive mounting of the inside seat member 66 is formed in the center of the upper wall 64.

The inside seat member 66 includes a mounting portion 66a of rod shape adapted to be mounted in the valve mounting hole 64a; and a seat portion 66b of round disk shape formed from the upper part of the mounting portion 66a and adapted to alternately seat against and unseat from the inside seal portion 33b; these are integrally molded from rubber material. The inside seat member 66 is attached to the inside float body 63 by inserting and mating the mounting portion 66a within the valve mounting hole 64a; and the seat portion 66b is adapted to undergo elastic deformation when seated against the inside seal portion 33b so as to enhance sealing.

(3) Operation of Fuel Cutoff Valve 10

### (3)-1 Operation During Fueling

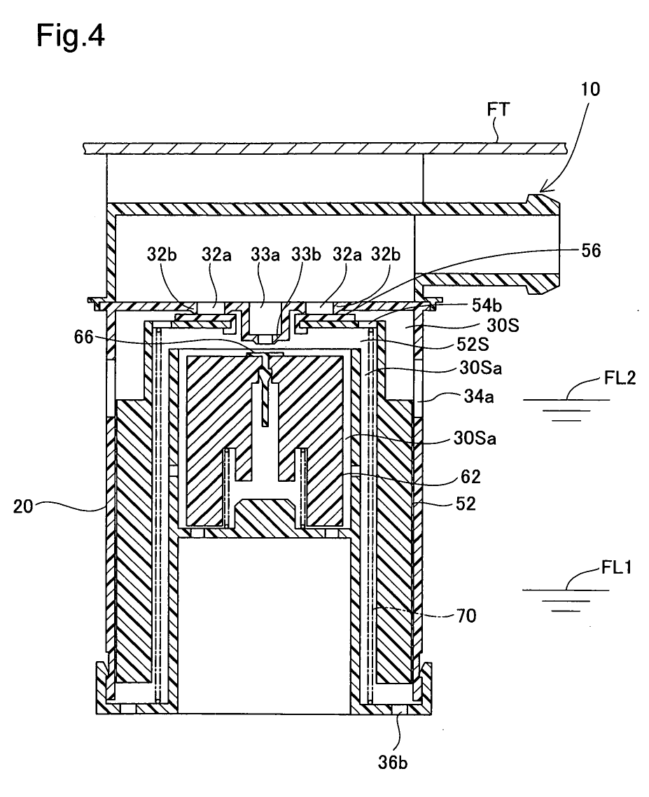

As depicted in FIG. 1, when fuel is supplied to the fuel tank FT during the fueling operation, as the fuel level in the fuel tank FT rises fuel vapors that have collected at the top of the fuel tank FT interior will escape to the canister through the vent 34a etc. and thence through the valve chamber 30S, the outside connecting passage 32a, the inside connecting passage 33a, and the tube passage 42a. Then, as depicted in FIG. 4, when the fuel level in the fuel tank FT passes the lower end of the casing 20, fuel will inflow through the communication hole 36b and into the outside valve chamber 30Sa in the valve chamber 30S; and when the level subsequently passes the first liquid level FL1, depending on the balance between upward force produced by the buoyancy of the outside float 52 and the load of the spring 70, and downward force produced by the weight of the outside float 52, if the former should exceed the latter the outside float 52 will rise and the outside seat member 56 will become seated against the outside seal portion 32b to close the outside connecting passage 32a. At this time, the only passage connecting the fuel tank FT to the outside will be that constituted by the vent hole 34a, the vent hole 54b, the valve chamber 30S, the float chamber 52S, and the inside connecting passage 33a; and due to the small passage area of the inside connecting passage 33a, tank internal pressure will rise and fuel will collect within the inlet pipe. When the fuel subsequently contacts the fuel gun, the auto stop will operate, preventing further fueling. In this way, during fueling of the fuel tank, fuel vapors can be prevented from escaping from the fuel tank, and fuel can be prevented from spilling out from the fuel tank.

On the other hand, as the fuel in the fuel tank FT is consumed and the fuel level drops, the fuel level in the valve chamber 30S will drop and the outside float 52 will decrease in buoyancy and descend. As the outside float 52 descends, the outside seat member 56 will unseat from the outside seal portion 32b to open up the outside connecting passage 32a.

(3)-2 Operation During Vehicle Pitch Etc.

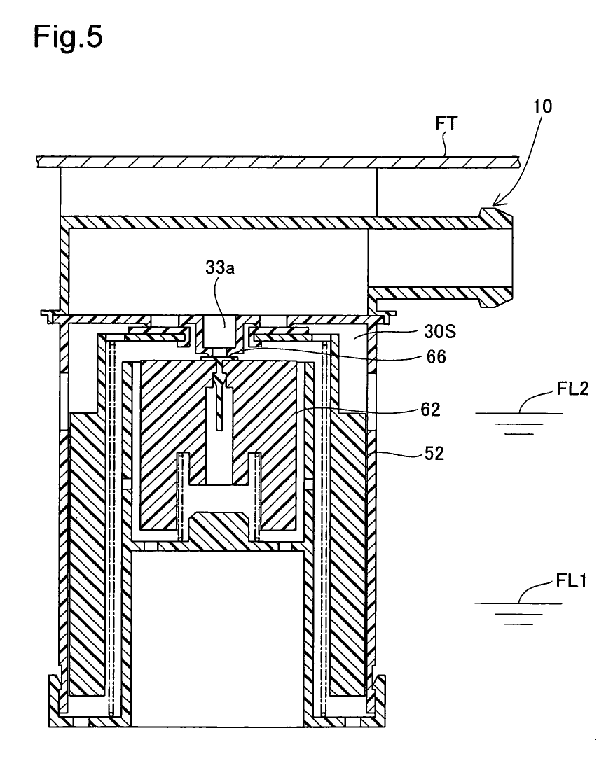

As depicted in FIG. 5, if the fuel level in the fuel tank FT should reach the second liquid level FL2 due to pitching of the vehicle for example, the fuel in the valve chamber 30S will cause the outside float 52 to float up as described earlier, and cause the inside float 62 to float up as well. When the inside float 62 floats up, the inside seat member 66 will seal off the inside connecting passage 33a, thus preventing fuel from spilling out from the fuel tank FT.

(4) Working Effects of the Embodiment

The constitution of the embodiment described above affords the following working effects.

(4)-1 Because the inside float 62 is housed within the float chamber 52S of the outside float 52, the space in the outside float 52 can be utilized efficiently to afford a compact design.

(4)-2 Since it suffices to form a valve chamber 30S capable of housing the large outside float 52 without the need to form valve chambers corresponding to multiple floats, the casing 20 can have a simpler design.

(4)-3 Since the outside float 52 has a round columnar shape, and the casing 20 also has a simple round tubular shape, there is no need for a complicated shape of multiple valve chambers that combines multiple tube sections, thus affording greater ease of die machining, formability, and parts design.

(4)-4 Moreover, since the outside float body 53 is provided in its upper part with a through-hole 54a, and the inside float 62 rises and falls so that inside valve portion of the inside float 62 opens and closes the inside connecting passage 33a through the through-hole 54a, a simple design whereby the two float portions are situated on the same axis can be achieved.

(4)-5 Since the casing 20 has a bottomed cup shape with the outside connecting passage 32a and the inside connecting passage 33a respectively formed in the upper wall 31, there is no need to provide respective connecting passages corresponding to multiple valve chambers that have been divided into multiple sections.

(4)-6 Because the guide portion 37 of the base member 35 guides the outside float body 52 and the inside float body 62 in the direction of their ascent and descent by the guide portions 37, tilting of these components can be reduced.

(4)-7 At times that the outside connecting passage 32a is closed off by the outside float 52 and the inside connecting passage 33a is left open by the inside float 62, the space to the outside of the outside float body 53 and the float chamber 52S will communicate through the vent hole 54b that has been formed in the outside float 52, thus making it a simple matter to realize a design for constricting passage area to a narrow area.

### B. Embodiment 2

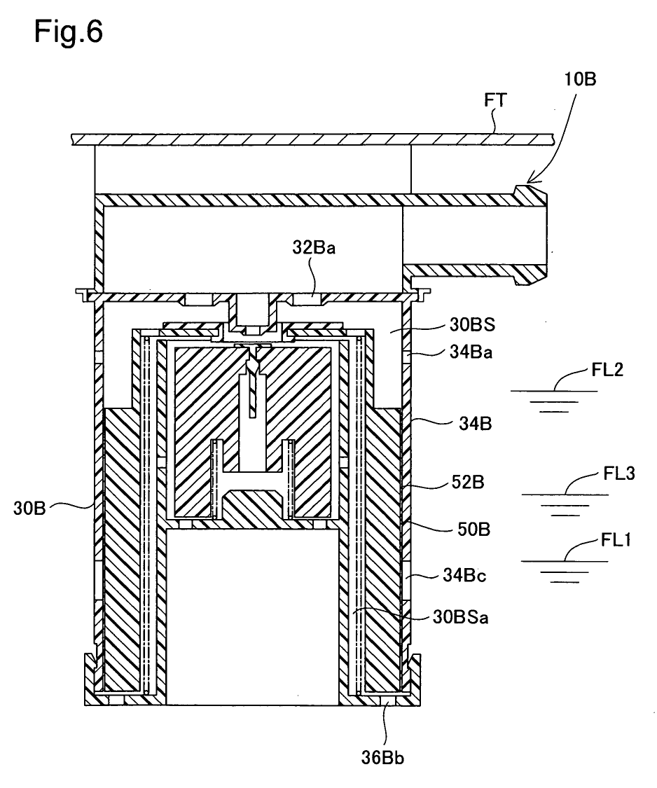

FIG. 6 is a sectional view depicting a fuel cutoff valve 10B according to a second embodiment. This embodiment features an arrangement whereby fuel is introduced into a valve chamber 30BS in response to a differential pressure between the valve chamber 30BS and the fuel tank FT, operating a float mechanism 50B. Specifically, a communication hole 34Bc is formed below a vent hole 34Ba in the side wall 34B of a casing body 30B. The vent hole 34Ba has a smaller passage area than the vent hole 34B of Embodiment 1. According to the design of this embodiment, when the fuel level reaches the top edge of the communication hole 34Bc and obstructs the communication hole 34Bc, fuel will be sucked into an outside valve chamber 30BSa of the valve chamber 30BS through a communication hole 36Bb due to the differential pressure between the tank internal pressure and the valve chamber 30Bs, and an outside float 52B will rise and close an outside connecting passage 32Ba. Tank internal pressure will rise thereby, causing the auto stop to operate. Then, as gases are introduced from the vent hole 34Ba and the fuel level inside the valve chamber 30BS drops, the outside float 52B will initially descend. Then, with additional fueling, the fuel level will rise gradually as fuel enters the outside valve chamber 30BSa, and when the fuel level reaches a third liquid level FL3, the outside float 52B will close the outside connecting passage 32Ba, halting further fueling. In this embodiment, additional fueling is permitted beyond the first liquid level FL1.

### C. Embodiment 3

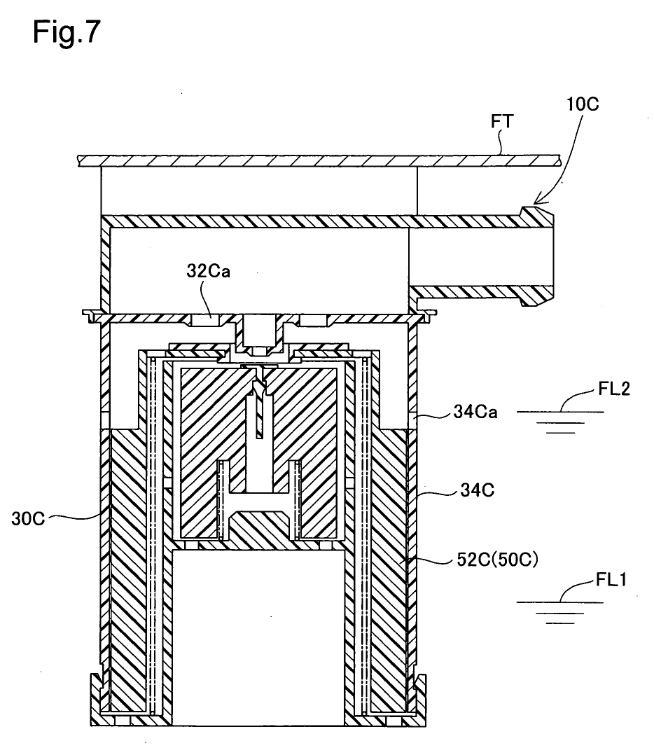

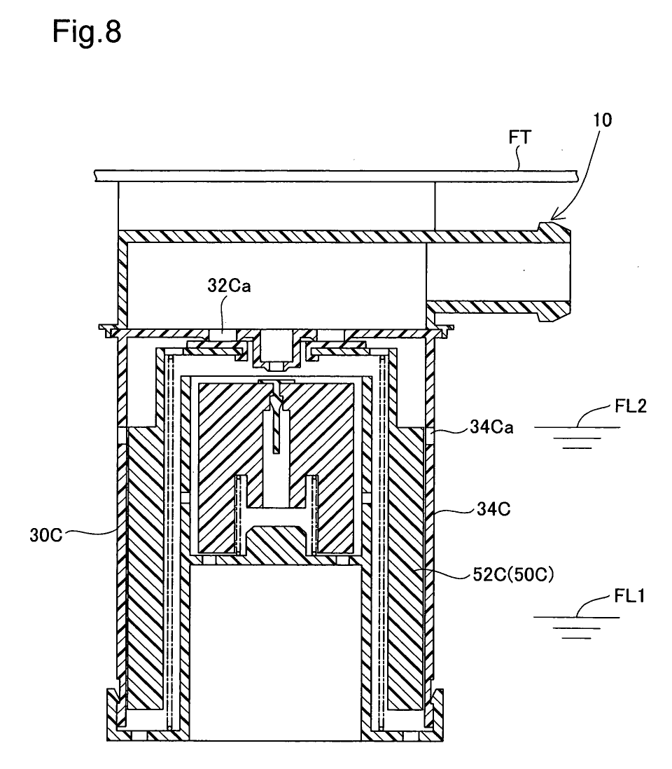

FIG. 7 is a sectional view depicting a fuel cutoff valve 10C according to a third embodiment. This embodiment features an arrangement whereby fuel leakage to the outside is prevented through a valve closing operation of an outside float 52C that is part of a float mechanism 50C. Specifically, a vent hole 34Ca formed in the side wall 34C of a casing body 30C will have a narrower passage area than the vent hole 34a of Embodiment 1; and as depicted in FIG. 8, will be formed such that with an outside float 52C in the up position, the upper part of the outside float 52C faces the vent hole 34Ca. With this arrangement, when the outside float 52C rises and closes an outside connecting passage 32Ca, the passage area of the vent hole 34a will be narrowed, thus reducing leakage to the outside from the fuel tank FT.

### D. Embodiment 4

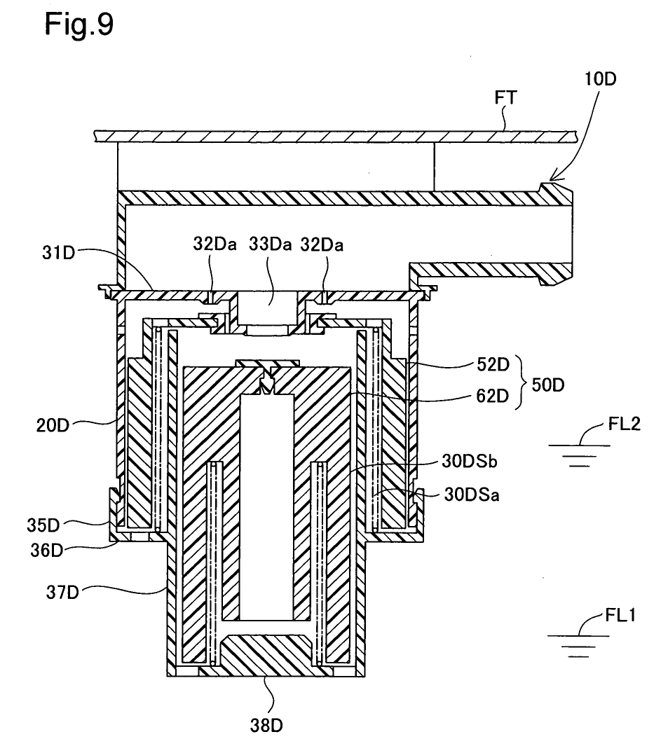

FIG. 9 is a sectional view depicting a fuel cutoff valve 10D according to a fourth embodiment. This embodiment features an arrangement whereby the fuel levels at which an outside float 52D and an inside float 62D rise and fall are reversed. Specifically, the fuel cutoff valve 10D includes a casing 20D and a float mechanism 50D. A base member 35 of the casing 20D includes an outside base plate 36D; a guide portion 37D of round tubular shape extending to below the outside base plate 36D; and an inside base plate 38D formed at the bottom of the guide portion 37D. The guide portion 37D is formed such that, with an inside valve chamber 30DSb positioned below an outside valve chamber 30DSa, fuel will be drawn into the inside valve chamber 30DSb at a low fuel level. An inside connecting passage 33Da formed in an upper wall 31D has a larger passage area than an outside connecting passage 32Da. With this arrangement, the inside float 62D will float at a first liquid level FL1, while the outside float 52D will float at a second liquid level FL2 higher than the first liquid level FL1, and respectively close the outside connecting passage 32Da and the inside connecting passage 33Da. Comparable working effects will be afforded despite the reversed order of rising and falling of the outside float 52D and the inside float 62D that make up the float mechanism 50D.

### E. Additional or Modified Embodiments

The present invention is not limited to the embodiments shown hereinabove, and may be embodied in various other modes without departing from the spirit and scope thereof. Modifications such as the following would be possible for example.

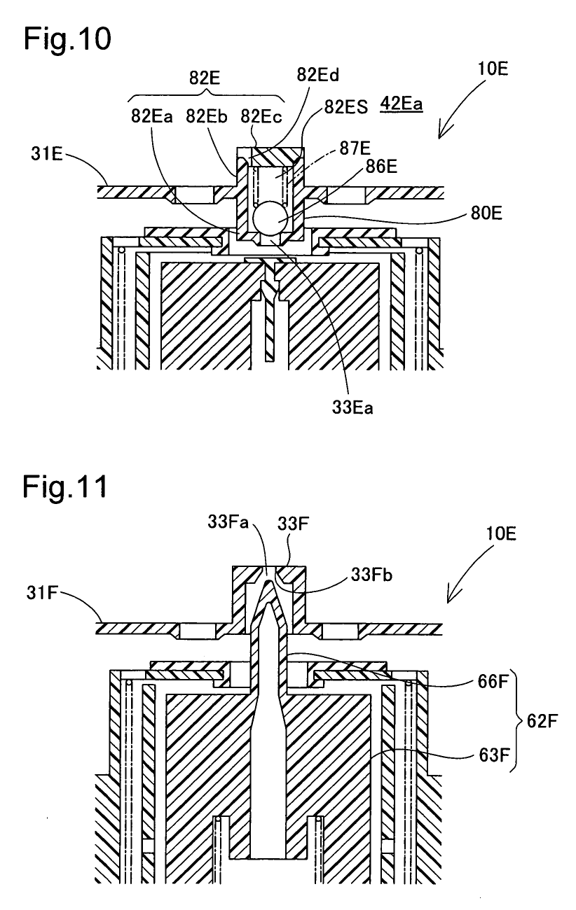

(1) FIG. 10 is a sectional view depicting principal parts of a fuel cutoff valve 10E according to a modified embodiment of FIG. 1. This embodiment features a pressure regulating valve for regulating tank internal pressure. The pressure regulating valve 80E includes a valve housing portion 82E formed in the center portion of an upper wall 31E; a ball valve 86E; and a spring 87E. In the valve housing portion 82E, a housing chamber 82ES is defined by a bottom wall 82Ea in which an inside connecting passage 33Ea is formed, a side wall 82Eb of round tubular shape, and a restraining member 82Ec. A cutout 82Ed for connecting the housing chamber 82ES to a tube passage 42Ea is formed in the restraining member 82Ec. In the pressure regulating valve 80E of the above design, when the ball valve 86E which receives the urging force of the spring 87E is subjected from the inside connecting passage 33Ea to pressure exceeding the urging force, the ball valve 86E will open up the inside connecting passage 33Ea so that tank internal pressure is maintained at or below a prescribed value. The pressure regulating valve may be implemented in the other embodiments described above; and while a ball valve is employed in this embodiment, no limitation is imposed thereby, and either a pivot valve or spool valve design would be acceptable as well.

(2) FIG. 11 is a sectional view depicting principal parts of a fuel cutoff valve 10F according to another modified embodiment of FIG. 1. This embodiment features an arrangement whereby an inside seal portion 33Fb of an inside connecting passage 33Fa is situated above an upper wall 31F. Specifically, the inside connecting passage 33Fa juts upward with round tubular contours from the upper wall 31F. The inside connecting passage 33Fa is formed passing through the upper wall of an inside passage-forming projection 33F. Meanwhile, in an inside float 62F, an inside valve portion 66F having a distal end of conical shape juts up from top center of an inside float body 63F. In the arrangement taught in this embodiment, when the inside valve portion 66F becomes seated against an inside seal portion 33Fb due to ascent of the inside float 62F, the inside connecting passage 33Fa will be closed off. In this embodiment, since the inside seal portion 33Fb is situated above the upper wall 31F, leakage of fuel to the outside through the inside connecting passage 33Fa will be reduced. Also, because according to the inside float 62F of this embodiment, the inside valve portion 66F has been integrally formed with the inside float body 63F, there is no need to use a valve made of rubber material, and the number of parts can be reduced.

(3) While in the preceding embodiments there is an intervening partition portion between the outside float and the inside float, this arrangement is not limiting, and an arrangement whereby the inside float is guided by the wall of the float chamber of the outside float would be acceptable as well.

(4) While the preceding embodiments describe a fuel cutoff valve of in-tank design adapted to be mounted inside the fuel tank, this design is not limiting and the fuel cutoff valve could instead be of a type adapted for installation on the tank top wall of the fuel tank, with the bottom part of the fuel cutoff valve being slipped through a mounting hole provided in the tank top wall. Also, while the fuel cutoff valve was described as being mounted onto a fuel tank made of steel via a bracket attached to the fuel tank, this design is not limiting and the valve could also be implemented in various kinds of fuel tanks made of composite materials including polyethylene. With such a design, the fuel cutoff valve could be attached to the fuel tank without the use of bracket, through thermal welding of the casing to the fuel tank, so that the number of parts can be reduced.

(5) While in the preceding embodiments the outside passage-forming projection 32 defines an outside seal portion 32b surrounding the arcuate outside connecting passages 32a about their entire circumference, this design is not limiting and it would be acceptable to instead form concentric annular projections that extend along the inside edge and outside edge of the outside connecting passages 32a.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel cutoff valve installed on a top of a fuel tank and adapted to open and close a conduit between the fuel tank interior and an outside passage depending on fuel level in the fuel tank, the fuel cutoff valve comprising:
a casing having (i) a valve chamber that communicates with the fuel tank interior, (ii) an outside connecting passage and an inside connecting passage that respectively connect with the valve chamber and with the outside passage, (iii) a communication hole for introducing fuel into the valve chamber, and (iv) a vent hole situated above the communication hole; and
a float mechanism having an outside float and an inside float that are housed within the valve chamber and that are respectively adapted to open and close the outside connecting passage and open and close the inside connecting passage by rising and falling depending on the fuel level;
wherein the outside float has (i) a tubular shaped outside float body having a float chamber that connects with the valve chamber via a through-hole formed in an upper part of the outside float body, and (ii) an outside valve portion disposed on an upper part of the outside float body and adapted to open and close the outside connecting passage; and
the inside float has (i) an inside float body accommodated within and adapted to rise and fall in the float chamber, and (ii) an inside valve portion disposed on an upper part of the inside float body and adapted to open and close the inside connecting passage through the through-hole.

2. The fuel cutoff valve in accordance with claim 1, wherein
the outside connecting passage has larger passage area than the inside connecting passage,
the outside float is configured to close the outside connecting passage when the fuel level in the fuel tank reaches a first liquid level, and
the inside float is configured to close the inside connecting passage when the fuel level in the fuel tank reaches a second liquid level higher than the first liquid level.

3. The fuel cutoff valve in accordance with claim 1, wherein
the outside connecting passage is formed with arcuate shape of prescribed width around the inside connecting passage.

4. The fuel cutoff valve in accordance with claim 1, wherein
the casing includes a tubular shaped casing body, and a base member that partially closes an opening at a bottom of the casing body, wherein the base member includes a guide portion that intervenes between the outside float body and the inside float body.

5. The fuel cutoff valve in accordance with claim 4, wherein
the base member includes an inner base plate that supports the inside float at a higher position than the outside float.

6. The fuel cutoff valve in accordance with claim 1, wherein
the outside float body includes a vent hole that communicates the float chamber with an outside space of the outside float body, wherein the vent hole is configured to flow gas when the outside connecting passage is closed by the outside float and the inside connecting passage is opened by the inside float.

7. The fuel cutoff valve in accordance with claim 1, wherein
the vent hole has a passage area such that a differential pressure is kept between tank internal pressure and pressure of the valve chamber, wherein the differential pressure is set in a value that the fuel is introduced into the valve chamber through the communication hole, and then the outside float rises, when the communication hole is obstructed by fuel in the fuel tank.

8. The fuel cutoff valve in accordance with claim 1, wherein
the vent hole faces an upper part of the outside float when the outside float rises, increasing air passage resistance.

9. The fuel cutoff valve in accordance with claim 1, wherein
the outside connecting passage has smaller passage area than the inside connecting passage,
the inside float closes the inside connecting passage when the fuel level inside the fuel tank reaches a first liquid level; and
the outside float closes the outside connecting passage when the fuel level inside the fuel tank reaches a second liquid level higher than the first liquid level.

10. The fuel cutoff valve in accordance with claim 1, wherein
the inside connecting passage includes a pressure regulating valve that regulates tank internal pressure.

11. The fuel cutoff valve in accordance with claim 1, wherein
the inside valve portion is of conical shape facing upward, and the inside connecting passage is situated above the outside connecting passage.

12. The fuel cutoff valve in accordance with claim 2, wherein
the outside connecting passage is formed with arcuate shape of prescribed width around the inside connecting passage.

13. The fuel cutoff valve in accordance with claim 2, wherein
the casing includes a tubular shaped casing body, and a base member that partially closes an opening at a bottom of the casing body, wherein the base member includes a guide portion that intervenes between the outside float body and the inside float body.

14. The fuel cutoff valve in accordance with claim 2, wherein
the outside float body includes a vent hole that communicates the float chamber with an outside space of the outside float body, wherein the vent hole is configured to flow gas when the outside connecting passage is closed by the outside float and the inside connecting passage is opened by the inside float.

15. The fuel cutoff valve in accordance with claim 2, wherein
the vent hole has a passage area such that a differential pressure is kept between tank internal pressure and pressure of the valve chamber, wherein the differential pressure is set in a value that the fuel is introduced into the valve chamber through the communication hole, and then the outside float rises, when the communication hole is obstructed by fuel in the fuel tank.

16. The fuel cutoff valve in accordance with claim 2, wherein
the vent hole faces an upper part of the outside float when the outside float rises, increasing air passage resistance.

17. The fuel cutoff valve in accordance with claim 2, wherein
the inside connecting passage includes a pressure regulating valve that regulates tank internal pressure.

18. The fuel cutoff valve in accordance with claim 2, wherein
the inside valve portion is of conical shape facing upward, and the inside connecting passage is situated above the outside connecting passage.

19. The fuel cutoff valve in accordance with claim 12, wherein
the casing includes a tubular shaped casing body, and a base member that partially closes an opening at a bottom of the casing body, wherein the base member includes a guide portion that intervenes between the outside float body and the inside float body.

20. The fuel cutoff valve in accordance with claim 12, wherein
the outside float body includes a vent hole that communicates the float chamber with an outside space of the outside float body, wherein the vent hole is configured to flow gas when the outside connecting passage is closed by the outside float and the inside connecting passage is opened by the inside float.
